(19) United States
(12) Patent Application Publication
(10) Pub. No.: US 2009/0027452 A1
(43) Pub. Date: Jan. 29, 2009

(54) REMOVABLE DRIVE ELECTRONICS UNIT FOR HIGH RESOLUTION PRINT ENGINE

(76) Inventors: David Doornink, Glen Carbon, IL (US); Kevin Kuester, Freeburg, IL (US)

Correspondence Address: MCANDREWS HELD & MALLOY, LTD, 500 WEST MADISON STREET, SUITE 3400, CHICAGO, IL, 60661, US

(21) Appl. No.: 11/781,750

(22) Filed: Jul. 23, 2007

(51) Int. Cl. B41J 2/07

(52) U.S. Cl. 347/50

(57) ABSTRACT

A print engine for drop-on-demand printing having a removable drive electronics unit and a removable ink jetting structure. The ink jetting structure may include an actuator mechanism, a nozzle, and a flexible circuit. The drive electronics unit may include an input port, at least one driver chip, and an outlet port. The inlet port may receive electronic data from an external information source and convert the received electronic data into electronic signals used to activate the actuator mechanism. The output port of the drive electronics and the flexible circuit may be removably connected through the use of an electronics connection device. This connection may allow the electronic signals generated by the drive electronics unit to be delivered to the actuator mechanism. These signals may control when the actuator mechanism is activated, thereby controlling the formation and jettison of ink droplets out of the nozzle of the ink jetting structure.

### BACKGROUND OF THE INVENTION

Embodiments of the present invention generally relate to a drop-on-demand printer. In particular, embodiments of the present invention relate to a system that allows for the separation of both the drive electronics unit and the ink jetting structure in the print engine of a drop-on-demand printer.

Drop-on-demand printing selectively allows ink droplets to be ejected onto a substrate only when the ink droplets are needed for printing. More specifically, with drop-on-demand printing, one or more ink droplets are ejected from a print engine at a specific time so that the jettisoned ink droplet lands at the desired location on a substrate. Determination of when each ink droplet is to be released may require consideration of a number of different factors, such as, the distance between the print engine and the substrate, the velocity of the jettisoned ink droplet, the speed of travel of the substrate and/or print engine relative to each other, and the location of the print engine relative to substrate, among others. By positioning the location of the ink droplets on the substrate through the controlled and timed release of each ink droplet, drop-on-demand printers do not require components that are often used by other types of printing systems, including charging tunnels for charging ink droplets, deflection electrodes, and recirculation systems.

A print engine in a drop-on-demand printer typically includes of an integrated structure to jet ink fluid (ink jetting structure) and an electrical means (drive electronics unit). The ink jetting structure may include an array of nozzles or orifices that are supplied with ink. Each nozzle is in communication with an ink pressure chamber, with each ink pressure chamber being operably connected to, or containing, an actuator mechanism. The actuator mechanism in drop-on-demand printers may employee a piezoelectric, thermal, electrostatic, or acoustic methodology, as is known in the art.

The actuator mechanism is configured to be selectively activated by signals from the drive electronics unit. When activated, the actuator mechanism affects the pressure in the ink pressure chamber. More specifically, activation of the actuator mechanism by the drive electronics unit results in the actuator mechanism increasing the pressure in the ink pressure chamber, which results in the formation of an ink droplet that is jettisoned out of the nozzle and onto the substrate. For example, if the actuator mechanism system is a piezoelectric mechanism, the mechanical motion of a piezoelectric oscillator or piezoelectric transducer may create a pressure wave in the ink pressure chamber that results in an ink droplet being generated and forcibly released from the nozzle of the ink jetting structure and onto the substrate. This process may be continuously repeated until a plurality of ink droplets are placed at desired locations on the substrate so as to create the desired image or character.

The integration of both the ink jetting structure and the electronic drive unit in one device may mean the print engine can be relatively small in size. Further, integrating these two functionalities together allows for one unified device, thereby eliminating the need for interconnecting cables. Additionally, any tuning between the drive electronics unit and ink jetting structure is built into one user replaceable unit.

However, the combination of the ink jetting structure and drive electronics unit in one device may be costly for the end-user and the manufacturer. In particular, the ink jetting structure and drive electronics unit are typically the two major costs in the print engine. By combining these two costly functionalities in one component, each functionality cannot be individually replaced, if needed. More specifically, if one functionality needs to be replaced, for example the ink jetting structure, the other functionality also will have to be replaced, regardless of whether or not that other functionality, in this example the drive electronics unit, is functioning properly. Therefore, the replacement cost for the end-user, or the scrap cost for the manufacture, associated with a print engine that has integrated the ink jetting and drive electronics functionalities together in one device may be costly.

### BRIEF SUMMARY OF THE INVENTION

Certain embodiments of the present invention provide a print engine for drop-on-demand printing having a removable ink jetting structure and a removable drive electronics unit. More specifically, embodiments of the present invention provide a system in which the ink jetting structure may be separated from the drive electronics unit, and the drive electronics unit may be separated from the ink jetting structure.

The ink jetting structure may include a main body, an ink supply intake, an actuator mechanism, a nozzle, and a flexible circuit. The actuator mechanism may employee a piezoelectric, thermal, electrostatic, or acoustic methodology. The flexible circuit may have a first end and a second end. In one embodiment, the first end of the flexible circuit may be permanently attached to the ink jetting structure. Alternatively, in another embodiment, the first end of the flexible circuit may be operably removable from the ink jetting structure.

The drive electronics unit may include an input port, at least one driver chip, and an output port. According to one embodiment of the present invention, the drive electronics unit may also include a printed circuit board. The driver chip may be operably configured to receive electronic data from an external information source, for example a computer, which is conveying information relating to the desired image that is to be printed on the substrate. The driver chip is configured to generate a plurality of signals responsive to the electronic data received from the external information source. The plurality of signals generated by the driver chip are used to control the activation of the ink jetting structure, and in particular, the activation of the actuation mechanism.

The drive electronics unit and the flexible circuit of the ink jetting structure may be removably connected to each other through the use of an electronics connection device. More specifically, the electronics connection device may allow the electronic connection between the drive electronics unit and the ink jetting mechanism to be disconnected, when, and if, necessary. Any such disconnection may also entail releasing any mechanical connection between the drive electronics unit and the ink jetting structure.

In one embodiment, the electronics connection device may be configured to operably connect the output port of the drive electronics unit with the second end of the flexible circuit. The removable connection between the output port of the drive electronics unit and the flexible circuit may allow for the passage of the plurality of signals that are generated by the at least one driver chip to be delivered to the actuator mechanism of the ink jetting structure. As previously mentioned, these signals may control when the actuator mechanism is activated, thereby controlling the formation and jettison of the ink droplets from the ink jetting structure and onto the adjacent substrate.

The electrical connection device may use a variety of different styles of electrical connectors, including a compression style connector or a conventional pin and socket style connector, among others. For example, according to one embodiment, the electronics connection device may employee a compression style connector, which may include a connector, a clamp bar, at least one fastener, and a mounting plate. Additional fasteners may also be employed to further mechanically secure the drive electronics to the mounting plate.

### BRIEF DESCRIPTION OF SEVERAL VIEWS OF THE DRAWINGS

FIG. 1 illustrates a top view of a standard print engine integrating both the drive electronics unit and ink jetting structure.

FIG. 2 illustrates a sectional view of a graphical representation of a drop-on-demand ink jetting structure incorporating an actuator mechanism having a piezoelectric transducer.

FIG. 3 illustrates an exploded view of a print engine according to one embodiment of the present invention.

FIG. 4 illustrates a top perspective view of a print engine according to one embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

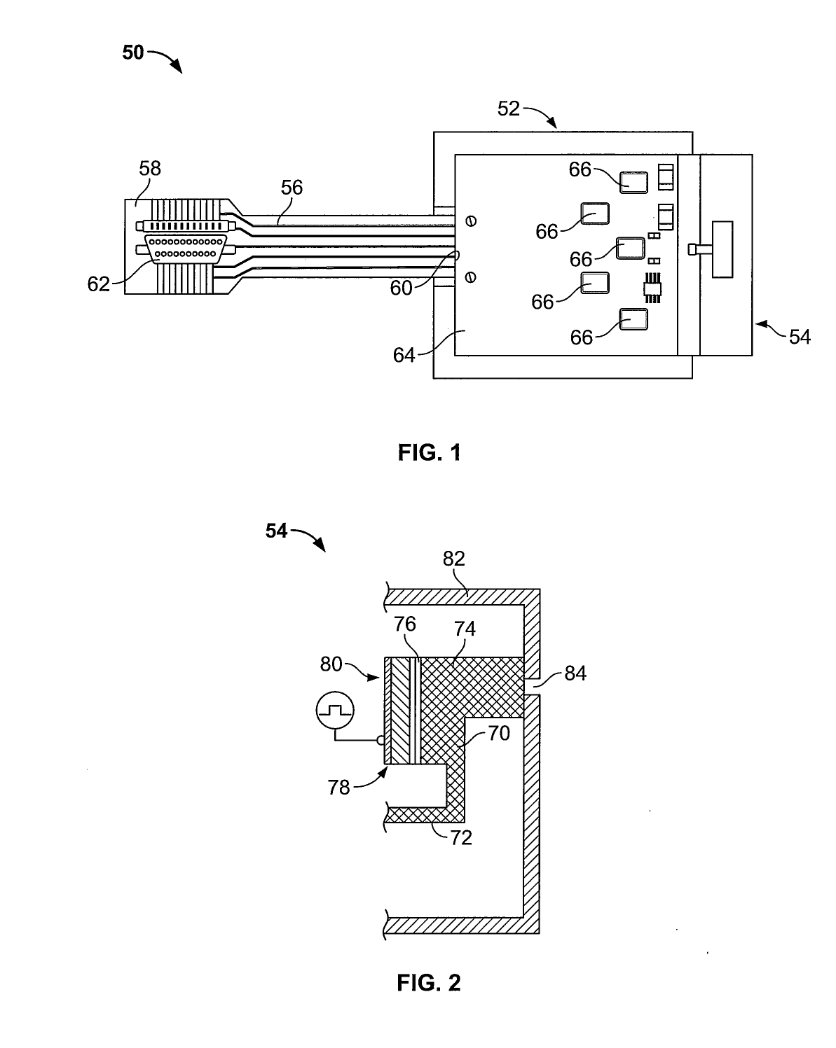

FIG. 1 illustrates a top view of a standard print engine 50 integrating both the drive electronics unit 52 and ink jetting structure 54 into one device. As shown, the standard print engine 50 may include an input circuit 56 having a first end 58 and a second end 60. The first end 58 of the input circuit 56 may include a connector, for example a conventional pin and socket style connector 62, that may be operably connected to an external information source, such as a computer or driver. The second end 60 may be permanently attached to the drive electronics unit 52. The drive electronics unit 52 may be configured to receive information through the input circuit 56 from the external information source, and, with through the use of driver chips 66, convert that information into electronic signals or electronic impulses that are used to control the formation and jettison of ink droplets from the ink jetting structure 54.

The drive electronics unit 52 of the standard print engine 50 illustrated in FIG. 1 is permanently attached to the ink jetting structure 54. For example, the drive electronics unit 52 of a standard print engine 50 may be permanently glued to the ink jetting structure 54.

FIG. 2 illustrates a sectional view of a graphical representation of a drop-on-demand ink jetting structure 54 incorporating an actuator mechanism 80 having a piezoelectric transducer 78. As discussed above, the actuator mechanism 80 of a drop on demand system may follow several different methodologies. Accordingly, FIG. 2 is intended for purposes of illustrating basic principles of drop-on-demand printing utilizing one form of the piezoelectric methodology.

As shown in FIG. 2, an ink jetting structure 54 incorporating a piezoelectric methodology may include a plurality of ink 70 along both an ink supply line 72 and in an ink pressure chamber 74. At least a portion of the ink pressure chamber 74 may include, or be operably connected to, a diaphragm 76. The diaphragm 76 may be attached to a piezoelectric transducer 78. The piezoelectric transducer 78 may be activated by electronic signals or electrical impulses that are generated by the driver chips 66. More specifically, these signals or electrical impulses may result in the mechanical movement of both the piezoelectric transducer 78 and the attached diaphragm 76, which may create a pressure wave in the ink pressure chamber 74. The creation of a pressure wave in the ink pressure chamber 74 may result in an ink droplet being generated and forcibly released from the ink pressure chamber 74 and through an orifice or nozzle 84 in the main body 82 of the ink jetting structure 54. The selective activation of the piezoelectric transducer 78 may result in the formation and jettison of only those ink droplets necessary to form the desired image on an adjacent substrate.

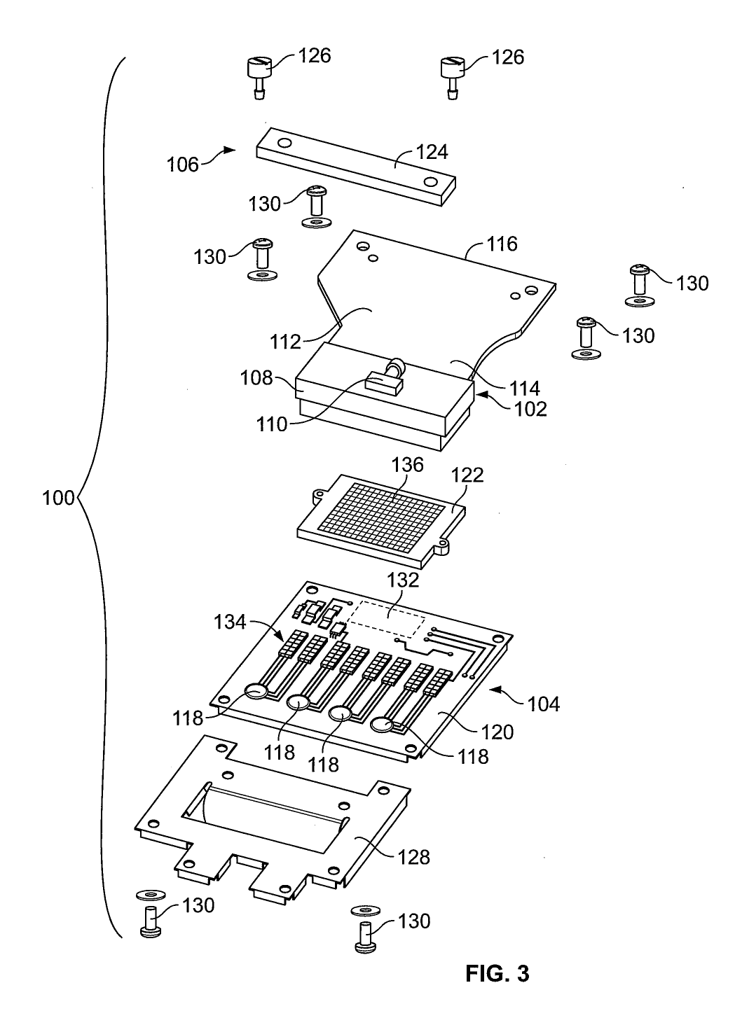

FIG. 3 illustrates an exploded view of a print engine 100 according to one embodiment of the present invention. As illustrated, the print engine 100 may include an ink jetting structure 102, a drive electronics unit 104, and an electrical connection device 106. The ink jetting structure 102 may include a main body 108 and an ink supply intake 110. The main body 108 may include at least one nozzle 84 and an actuator mechanism 80. Ink 70 may be received into the main body 108 of the ink jetting structure 102 and dispersed into a manifold. The manifold may supply an ink pressure chamber 74 within the main body 108 with ink 70.

The ink pressure chamber 74 may include, or be operably connected to, an actuator mechanism 80. As previously stated, the actuator mechanism 80 in drop-on-demand printers may employee a piezoelectric, thermal, electrostatic, or acoustic methodology. For example, the actuator mechanism 80 may include a piezoelectric oscillator, a piezoelectric transducer 78, a heater, an ejection electrode, or an acoustic beam generator, among others. Further, the ink pressure chamber 74 may be in communication with at least one nozzle 84 through which ink droplets may be jettisoned from the ink jetting structure 102 and toward the substrate. In one embodiment, the nozzle 84 may be an orifice in the main body 108.

The flexible circuit 112 may include a first end 114 and a second end 116. The first end 114 of the flexible circuit 112 may be configured to be operably connected to the actuator mechanism 80. In one embodiment of the present invention, the first end 114 of the flexible circuit 112 may be permanently connected to the ink jetting structure 102.

The drive electronics unit 104 may include an input port 132, at least one driver chip 118, and an output port 134. The driver chip 118 may be placed on a fiberglass circuit board 120. The use of a fiberglass circuit board 120 may allow the drive electronics unit 104 to be sized and/or configured to fit the specific application package of different printers.

The input port 132 of the drive electronics unit 104 may be operably connected to an external information source, such as a computer. In one embodiment, the input port 132 may be a terminal for a pin and socket style electrical connection. The external information source may provide electronic data regarding the desired image and/or text that is to be printed on the substrate, including data regarding size, shapes, and/or colors, among others. This electronic data may be received through the input port 132 and delivered to the driver chip 118 The driver chip 118 may use this data to generate electronic signals or electronic impulses that activate the actuator mechanism of the ink jetting structure 102. These electronic signals or electronic impulses may be delivered to the output port 134 of the drive electronics unit 104.

The output port 134 of the drive electronics unit 104 may be operably connected to the second end 116 of the flexible circuit 112 by an electrical connection device 106. The electrical connection device 106 may use a variety of different styles of electrical connectors, including a compression style connector or a conventional pin and socket style connector, among others. The output port 134 of the drive electronics unit 104 and the second end 116 of the flexible circuit 112 may be configured to work with a specific style of electronic connection. Further, the selected electrical connection device 106 may also mechanically fasten the drive electronics unit 104 with the ink jetting structure 102. In such an embodiment, the disconnection of the electrical connection device 106 may separate the mechanical connection between the ink jetting structure 102 and the drive electronics unit 104, thereby assisting in the removal of either the ink jetting structure 102 or the drive electronics unit 104 from the print engine 100 independently of each other.

According to one embodiment, the electrical connection device 106 may be a compression style connector that includes a connector 122, a clamp bar 124, fasteners 126, and a mounting plate 128. The connector 122 may include a plurality of contacts 136. In such an embodiment, when under compression, the contacts 136 may act as interconnecting springs that are compressed between the traces of the flexible circuit 112 and the output port 134 of the drive electronics unit 104. Accordingly, the size, shape, and tracing of the output port 134 of the drive electronics unit 104 and the second end 116 of the flexible circuit 112 may be configured to work with the configuration of the compression connector 122.

Additionally, according to one embodiment, the clamp bar 124, connector 122, flexible circuit 112, drive electronics unit 104, and mounting plate 128 may be configured to receive or allow for the passage of at least a portion of at least one fastener 126. Suitable types of fasteners 126 include thumb screws, among others. In such an embodiment, the mounting plate 128 may include at least one aperture having an internal thread that mates the thread of the fastener 126. Accordingly, after at least a portion of the fastener 126 has been inserted in through-holes in the clamping bar 124, connector 122, flexible circuit 112, and the drive electronics unit 104, the fastener 126 may engage the mating threads of an aperture in the mounting plate 128. By engaging the mating threads of the fasteners 126 and the mounting plate 128 may be brought together to compress at least a portion of the connector 122, flexible circuit 112, and drive electronics unit 104, while also resulting in a mechanical connection there-between.

Additional fasteners 130 may also be used to operably connect, or further secure, components of the print engine 100 to the mounting plate 128. These mechanical connections may further assist in the durability of the print engine 100, including the durability of the print engine 100 while it is being handled or manipulated during manufacturing, shipping, and repairs.

As previously stated, activation of the actuator mechanism 80 may result in the formation of an ink droplet from the ink pressure chamber that is jettisoned away from the main body 108 through the nozzle 84. For instance, if the actuator mechanism 80 utilizes a piezoelectric transducer 78, electronic impulses from the drive electronics unit may be converted by the piezoelectric transducer 78 into mechanical movement in the ink pressure chamber 74. Such mechanical movement may result in the formation of at least one ink droplet from the ink pressure chamber 74 that is jettisoned out of the nozzle 84 and onto the adjacent substrate at the desired location.

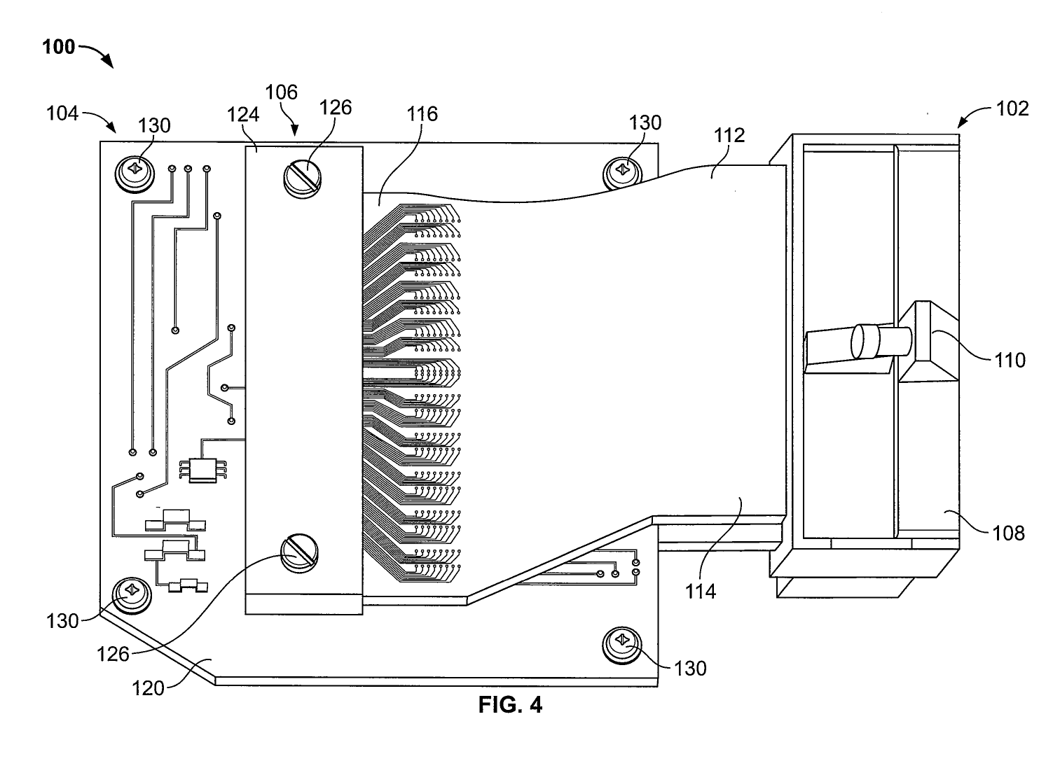

FIG. 4 illustrates a top perspective view of a print engine 100 according to one embodiment of the present invention. As shown, the print engine 100 includes a drive electronics unit 104 and an ink jetting structure 102. The drive electronics unit 104 may include driver chips 118 that are operably connected to a circuit board 120. The ink jetting structure 102 may include a main body 108, an ink supply intake 110, and a flexible circuit 112. As previously mentioned, in one embodiment the first end 114 of the flexible circuit 112 may be permanently attached to at least a portion of the ink jetting structure 102. The second end 116 of the flexible circuit 112 may be removably connected to at least a portion of the circuit board 120 through the use of a electrical connecting device 106, which, according to an embodiment, may include a clamp bar 124 and fasteners 126. The circuit board 120 may also be attached to a mounting plate 128 (not shown) through the use of additional fasteners 130.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A print engine comprising:
a drive electronics unit, said drive electronics unit comprising at least one driver chip, and input port, and an output port, said input port operably connected to receive electronic information from an external information source;
an ink jetting structure, said ink jetting structure comprising a main body, an ink supply intake, an actuator mechanism, a nozzle, and a flexible circuit, said flexible circuit having a first end and a second end; and
an electronics connection device, said electronics connection device configured for the removable connection of said output port of said drive electronics unit with said second end of said flexible circuit.

2. The print engine of claim 1, wherein said actuator mechanism is a piezoelectric mechanism.

3. The invention of claim 2, wherein said at least one driver chip is attached to a printed circuit board.

4. The invention of claim 1, wherein said electronics connection device includes a connector, a clamp bar, at least one fastener, and a mounting plate.

5. The invention of claim 4, wherein said first end of said flexible circuit is permanently attached to said ink jetting structure.

6. The invention of claim 4, wherein said drive electronics unit is at least partially attached to said mounting plate with at least one additional fastener.

7. The invention of claim 1, wherein said electronics connection device includes a compressions style connector for the removable connection of said output port of said drive electronics unit with said second end of said flexible circuit.

8. A print engine comprising:
a drive electronics unit, said drive electronics unit comprising at least one driver chip, said at least one driver chip configured to receive electronic data from an external information source, said at least one driver chip configured to generate a plurality of electronic signals;
an ink jetting structure, said ink jetting structure comprising a main body, an ink supply intake, an actuator mechanism, a nozzle, and a flexible circuit, said flexible circuit having a first end and a second end; and
an electronics connection device, said electronics connection device comprising a connector, a clamp bar, and at least one fastener, said electronics connection device configured for the removable connection of said drive electronics unit with said second end of said flexible circuit.

9. The print engine of claim 8, wherein said actuator mechanism is a piezoelectric mechanism.

10. The invention of claim 8, wherein said drive electronics unit further includes an input port and an output port, said input port operably connected to receive electronic information from an external information source, said output port operably connected to said second end of said flexible circuit.

11. The invention of claim 8, wherein said at least one driver chip is attached to a printed circuit board.

12. The invention of claim 8, wherein said electronics connection device further includes a mounting plate.

13. The invention of claim 12, wherein said drive electronics unit is at least partially attached to said mounting plate with at least one additional fastener.

14. The invention of claim 8, wherein said first end of said flexible circuit is permanently attached to said ink jetting structure.

15. The invention of claim 8, wherein said electronics connection device includes a compression style connector for the removable connection of said flexible circuit with said ink jetting structure.

16. The invention of claim 8, wherein said electronics connection device includes a pin and socket style connector for the removable connection of said flexible circuit with said ink jetting structure.

17. A print engine comprising:
a drive electronics unit, said drive electronics unit comprising an input port, at least one driver chip, an output port, and a printed circuit board, said at least one driver chip configured to receive electronic data from an external information source, said at least one driver chip configured to generate a plurality of signals responsive to the electronic data received by said at least one driver chip;
an ink jetting structure, said ink jetting structure comprising a main body, an ink supply intake, an piezoelectric actuator mechanism, a nozzle, and a flexible circuit, said flexible circuit having a first end and a second end; and
an electronics connection device, said electronics connection device comprising a connector, a clamp bar, at least one fastener, and a mounting plate, said electronics connection device configured for the removable connection of said drive electronics unit with said second end of said flexible circuit, the removable connection between said output port of said drive electronics unit and said flexible circuit configured for the passage of said plurality of signals generated by said drive electronics unit to said piezoelectric actuator mechanism, said plurality of signals generated to control the activation of said piezoelectric actuator mechanism.

18. The invention of claim 17, wherein said first end of said flexible circuit is permanently attached to said ink jetting structure.

19. The invention of claim 17, wherein said electronics connection device includes a compression style connector for the removable connection of said flexible circuit with said ink jetting structure.

20. The invention of claim 17, wherein said drive electronics unit is at least partially attached to said mounting plate with at least one additional fastener.
